(19) United States
(12) Patent Application Publication
(10) Pub. No.: US 2016/0266743 A1
(43) Pub. Date: Sep. 15, 2016

(54) SYSTEM, METHOD, AND STORAGE MEDIUM STORING PROGRAM FOR DISTRIBUTING VIDEO OR AUDIO

(71) Applicant: DeNA Co., Ltd., Tokyo (JP)

(72) Inventors: Yuji MAEDA, Tokyo (JP); Yasunobu SASAKI, Tokyo (JP)

(21) Appl. No.: 15/063,983

(22) Filed: Mar. 8, 2016

(30) Foreign Application Priority Data
Mar. 10, 2015 (JP) 2015-046729

(51) Int. Cl. G06F 3/0482; H04N 21/472; H04N 21/431; G06F 3/0484

(52) U.S. Cl. CPC G06F 3/0482; G06F 3/04842; G06F 3/04847; H04N 21/47202; H04N 21/47205; H04N 21/4316

(57) ABSTRACT

To facilitate setting an image displayed at the time of audio distribution, a server according to one embodiment includes an information storage unit, a user information management unit that performs various processing concerning management of user information, and a content distribution control unit that controls content distribution. The user information management unit specifies, based on distributor-user related information, a recommended preset image from among a plurality of preset images provided in advance, and sets, as a display-image, one image selected from among one or more images including the recommended preset image. The content distribution control unit presents a distributor user screen on which the user can instruct switching between video or audio distribution. The unit further presents, to an audience user, an audience user screen that has a display region where video is displayed when the video is distributed and a display-image is shown when audio is distributed.

### CROSS-REFERENCE TO RELATED APPLICATIONS

This application is based on and claims the benefit of priority from Japanese Patent Application Serial No. 2015-046729 (filed on Mar. 10, 2015), the contents of which are hereby incorporated by reference in their entirety.

### TECHNICAL FIELD

The present disclosure relates to a system, method, and storage medium storing a program for distributing video or audio, more particularly, a system, method, and storage medium storing a program for distributing video or audio by a distributor user to an audience user.

### BACKGROUND

Systems for distributing contents via Internet or the like by a user have been known (for instance, see Japanese Patent Application Publication 2012-120098). Some systems allow a user who distributes contents to select between video that includes images and sounds or audio that does not include images to be distributed. According to the system where the user can select video or audio to be distributed, when the video is distributed, the video is shown on a display of an audience user who watches the content, whereas when the audio is distributed, the display shows a display-image such as a still image instead of videos.

However, in many such conventional systems, the display image shown at the time of audio distribution needs to be set in advance by the distributor user and some users may feel the setting of the display image as cumbersome. To facilitate the setting for the distributor user, for instance, an image provided by a system operator may be set as the display image. However, if a plurality of distributor users set the identical image as the display image, audience users may feel a dull uniformity and lose interest in the contents. Therefore it is desirable to provide a system to support distributor users to set an image displayed at the time of audio distribution thereby the distributor users can easily set various images as the display image.

One object of the disclosure is to facilitate setting an image to be displayed at the time of audio distribution by a user. Other objects of the embodiments of the present disclosure will be apparent with reference to the entire description in this specification.

### SUMMARY

A system according to one embodiment of the disclosure is for distributing video or audio by a distributor user to an audience user. The system includes one or more computer processors, and the one or more computer processors execute a readable instruction to perform: specifying, from among a plurality of preset images, at least one prescribed image that is to be recommended as a display-image for a distributor user based on distributor-user related information associated with the distributor user; setting, as the display-image for the distributor user, one image selected from among one or more images including the at least one prescribed image; in response to a request from a distributor user, presenting, to the distributor user, a distributor user screen on which the distributor user can instruct switching between video distribution or audio distribution; and in response to a request from an audience user, presenting, to the audience user, an audience user screen that includes a display region where video is shown when the video is distributed by the distributor user and the display-image is shown when audio is distributed by the distributor user.

A method according to one embodiment of the disclosure is implemented by one or more computers for distributing video or audio by a distributor user to an audience user. The method includes: specifying, from among a plurality of preset images, at least one prescribed image that is to be recommended as a display-image for a distributor user based on distributor-user related information associated with the distributor user; setting, as the display-image for the distributor user, one image from among one or more images including the at least one prescribed image; in response to a request from a distributor user, presenting, to the distributor user, a distributor user screen on which the distributor user can instruct switching between video distribution or audio distribution; in response to a request from an audience user, presenting, to the audience user, an audience user screen that includes a display region where video is shown when the video is distributed by the distributor user and the display-image is shown when audio is distributed by the distributor user.

A storage medium storing a program according to one embodiment of the disclosure is for distributing video or audio by a distributor user to an audience user. The program being configured to cause, upon execution on a computer, the computer to perform: specifying, from among a plurality of preset images, at least one prescribed image that is to be recommended as a display-image for a distributor user based on distributor-user related information associated with the distributor user; setting, as the display-image for the distributor user, one image from among one or more images including the at least one prescribed image; in response to a request from a distributor user, presenting, to the distributor user, a distributor user screen on which the distributor user can instruct switching between video distribution or audio distribution; and in response to a request from an audience user, presenting, to the audience user, an audience user screen that includes a display region where video is shown when the video is distributed by the distributor user and the display-image is shown when audio is distributed by the distributor user.

According to various embodiments of the disclosure, it is possible to facilitate setting, by a user, an image to be displayed at the time of audio distribution.

### BRIEF DESCRIPTION OF THE DRAWINGS

FIG. 1 is a configuration diagram schematically illustrating a network configuration including a server 10 according to an embodiment of the disclosure.

FIG. 2 is a block diagram illustrating the functionality of the server 10 according to an embodiment.

FIG. 3 is a diagram showing an example of information managed in a user information management table 41a according to an embodiment.

FIG. 4 is a diagram showing an example of information managed in a distribution state management table 41b according to an embodiment.

FIG. 5 is a flow diagram showing an example of a display-image presetting process according to an embodiment.

FIG. 6 illustrates an example of a menu screen 50A (image selection screen) according to an embodiment.

FIG. 7 illustrates an example of a recommended image selection screen SOB (image selection screen) according to an embodiment.

FIG. 8 is a flow diagram showing an example of a display-image updating process according to an embodiment.

FIG. 9 is a diagram showing an example of a distributor user screen 60 according to an embodiment.

FIG. 10 is a diagram showing an example of the audience user screen 70 according to an embodiment.

FIG. 11 is a diagram showing an example of the audience user screen 70 according to an embodiment.

### DESCRIPTION OF THE PREFERRED EMBODIMENTS

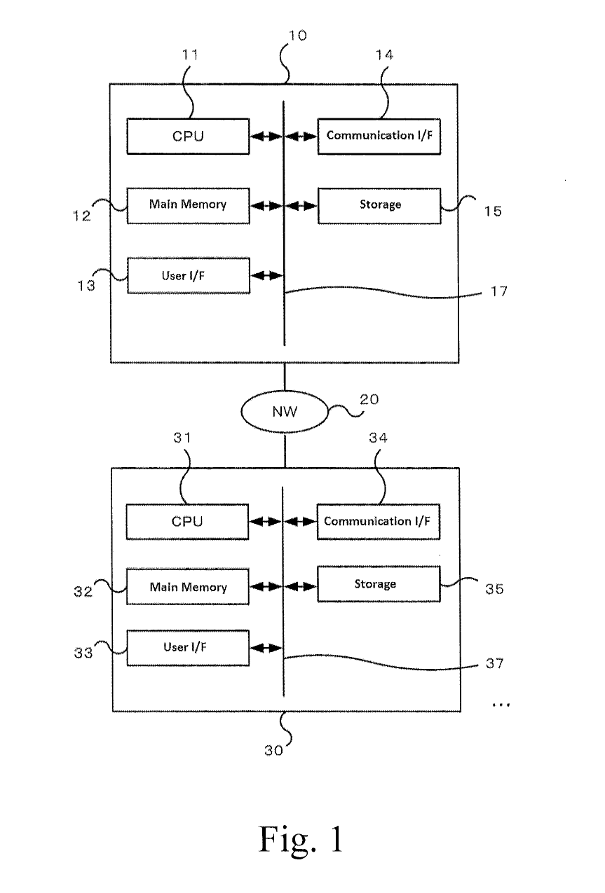

FIG. 1 is a configuration diagram schematically illustrating a network configuration including a server 10 according to an embodiment of the disclosure. As shown in FIG. 1, the server 10 according to the embodiment may be communicatively connected to terminals 30 via a communication network 20 such as the Internet, and may serve as a system that provides users of the terminals 30 with a content distribution service through which distributor users deliver video or audio to audience users.

As illustrated, the server 10 according to the embodiment is configured as a common computer device and may include a central processing unit (CPU) (computer processor) 11, a main memory 12, a user interface (I/F) 13, a communication I/F 14, and a storage 15, and these components may be electrically connected to one another via a bus 17. The CPU 11 may load an operating system and various other programs into the main memory 12 from the storage 15, and may execute commands included in the loaded programs. The main memory 12 may be used to store a program to be executed by the CPU 11, and may be formed of, for example, a dynamic random access memory (DRAM) or the like. The server 10 according to an embodiment may be configured from computer devices that have the above-described hardware configurations.

The user I/F 13 may include, for example, an information input device such as a keyboard and a mouse for accepting an input from an operator, and an information output device such as a liquid crystal display for outputting calculation results of the CPU 11. The communication I/F 14 may be implemented as hardware, firmware, or communication software such as a transmission control protocol/Internet protocol (TCP/IP) driver or a point-to-point protocol (PPP) driver, or a combination thereof, and may be configured to be able to communicate with the terminals 30 via the communication network 20.

The storage 15 may be formed of, for example, a magnetic disk drive and store various programs such as a control program for controlling the provision of the content distribution service described above. The storage 15 may also store various data used in the content distribution service. The various data that may be stored in the storage 15 may also be stored on a database server communicatively connected to the server 10 and physically separate from the server 10.

In an embodiment, the server 10 may function as a web server for managing a web site including a plurality of hierarchical web pages and may provide the users of the terminals 30 with the content distribution service through the web site. The storage 15 may also store the HTML data corresponding to the web page. Additionally, the HTML data may include programs written in script languages such as JavaScript™.

In an embodiment, the server 10 may provide the content distribution service to the user of the terminal 30 through applications executed on execution environments other than a web browser on the terminal 30. The storage 15 may also store such applications. The game application programs may be created in, for example, programming languages such as Objective-C™ and Java™. The application stored on the storage 15 may be delivered to the terminal 30 in response to a delivery request. The terminal 30 may download such applications from a server (a server providing application markets) other than the server 10.

Thus, the server 10 may manage the web site for providing the content distribution service and deliver web pages (HTML data) constituting the web site in response to a request from the terminal 30, thereby providing the content distribution service to a user of the terminal 30. Also, the server 10 can provide the content distribution service based on communication with an application performed on the terminal 30 in place of, or in addition to, such web-page (web browser)-based service. The server 10 can transmit and receive various data (including data necessary to display a screen) to/from the terminal 30 in order to provide the content distribution service in any manner. The server 10 can store various types of data that are required to provide the service. The server 10 may store such data for each piece of identification information (for example, user ID) that identifies each user and thereby can manage the status of the service provided to each user. Briefly, the server 10 may also include a function to authenticate a user at start of the service and perform charging process in accordance with provision of the service.

The terminal 30 according to an embodiment may be any information processing device that may display on a web browser a web page of a web site provided by the server 10 and include an executing environment for executing applications. As an example of such information processing device may include personal computers, smartphones, tablet terminals, wearable devices, and game-dedicated terminals.

As illustrated in FIG. 1, the terminal 30 may be configured as a typical computer device that includes a central processing unit (CPU) (computer processor) 31, a main memory 32, a user interface (I/F) 33, a communication I/F 34, and storage 35, and these component may be electrically interconnected via a bus 37.

The CPU 31 may load an operating system and various other programs into the main memory 32 from the storage 35, and may execute commands included in the loaded programs. The main memory 32 may be used to store a program to be executed by the CPU 31, and may be formed of, for example, a dynamic random access memory (DRAM) or the like.

The user I/F 33 may include, for example, an information input device such as a touch panel, a keyboard, a button, and a mouse for accepting an input from a user, and an information output device such as a liquid crystal display for outputting calculation results of the CPU 31. The communication I/F 34 may be implemented as hardware, firmware, or communication software such as a transmission control protocol/Internet protocol (TCP/IP) driver or a point-to-point protocol (PPP) driver, or a combination thereof, and may be configured to be able to communicate with the server 10 via the communication network 20.

The storage 35 may comprise, for example, a magnetic disk drive or a flash memory and store various programs such as an operating system. The storage 35 may also store various applications received from the serve 10 and the like.

The terminal 30 may include, for example, a web browser for interpreting an HTML file (HTML data) and rendering a screen; this web browser may enable the terminal 30 to interpret the HTML data fetched from the server 10 and render web pages corresponding to the received HTML data. A plug-in software that can execute files of various formats associated with the HTML data may be embedded in the web browser of the terminal 30.

When a user of the terminal 30 uses various services provided by the server 10, for example, animation or an operation icon designated by HTML data or applications may be displayed on a screen of the terminal 30. A user can input various instructions via a touch panel or the like of the terminal 30. The instruction entered by the user may be transmitted to the server 10 through the web browser or a function of an execution environment such as NgCore™ on the terminal 30.

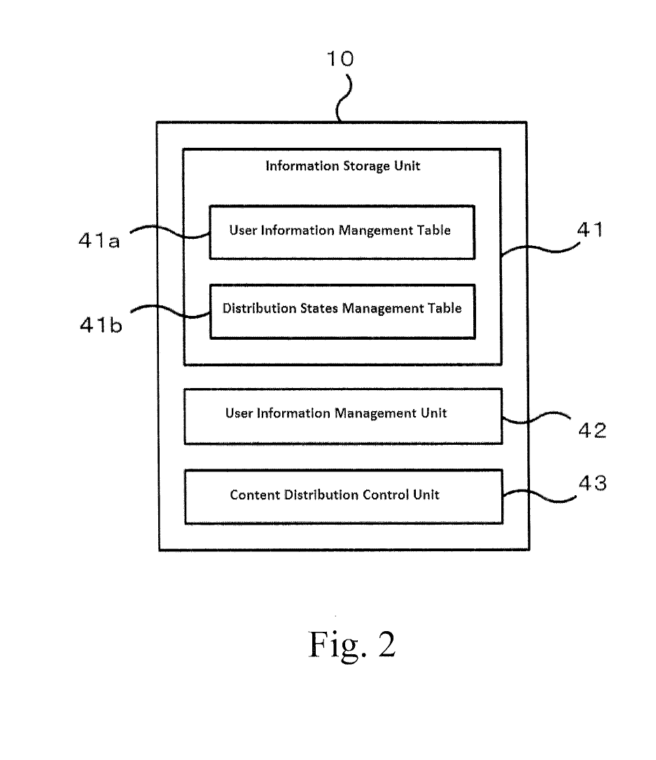

Next, functionality of the server 10 according to an embodiment will be described. FIG. 2 is a block diagram illustrating the functionality of the server 10 according to an embodiment. As illustrated in FIG. 2, the server 10 according to the embodiment may include an information storage unit 41 that store information, a user information management unit 42 that performs various processing concerning management of user information, and a content distribution control unit 43 that controls content distribution. These functionalities may be implemented by cooperation between hardware such as the CPU 11 and the main memory 12 and various programs and tables stored on the storage 15. An example of such cooperation may be execution of instructions included in a loaded program by the CPU 11. Further, a part or all of the functions of the server 10 illustrated in FIG. 2 may be realized with the terminal 30 or implemented through cooperation between the server 10 and the terminal 30.

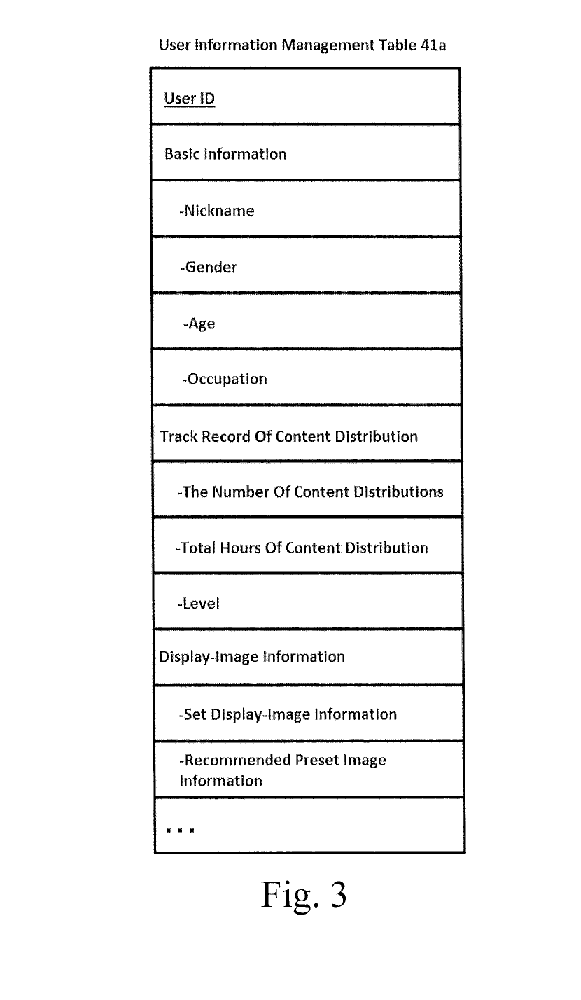

The information storage unit 41 may be implemented as the storage 15 or the like. The information storage unit 41 may include a user information management table 41a that manages information about users of the content distribution service, and a content distribution state management table 41b that manages distribution states of individual contents. FIG. 3 is a diagram showing an example of information managed in the user information management table 41a according to an embodiment. Referring to FIG. 3, the user information management table 41a manages, in association with a “user ID” identifying individual user, basic information about the user, a track record of content distributions by the user, and display-image information that is information about a display-image displayed at the time of audio distribution instead of video, and the like. Here, the basic information may include, for example, “nickname,” “gender,” “age,” “occupation,” and the like. The track record of content distributions may include, for example, “the number of content distributions” which indicates how many times a user performed content distributions, “total time of content distribution” which is the cumulative total of time duration for which the user performed the content distributions, a “level” that is updated based on the number of content distributions and the total time of content distribution, and the like. The display-image information may include “set display-image information” which is information about an image set as the display-image for a user, “recommended preset image information” which is information about a preset image to be recommended to a user as the display-image, and the like. Among the above-mentioned information, the basic information may be provided by a user when the user newly signs up with a content distribution service or at any other occasions. The track record of content distributions may be updated each time a user performs a content distribution. A process to register the display-image information will be described later in detail. The user information management table 41a may also manage information about audience users who do not distribute contents.

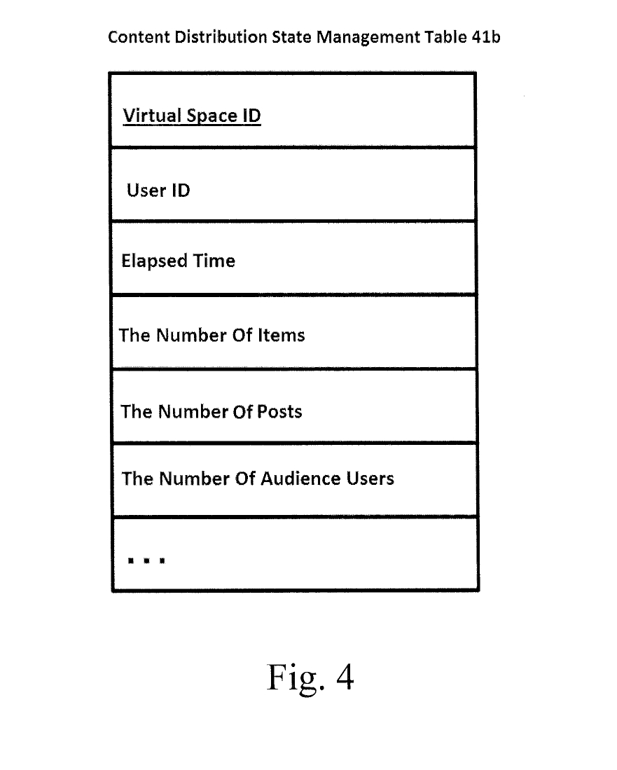

FIG. 4 is a diagram showing an example of information managed in the distribution state management table 41b according to an embodiment. The content distribution state management table 41b may manage the “user ID” of a distributor user, an “elapsed time” since the start of the content distribution, “the number of items” indicating how many items are provided by audience users who view the content during the distribution of the content, “the number of posts” indicating how many times audience users posted comments during the distribution of the content, and “the number of audience users” indicating how many audience users have viewed the content. The content distribution state management table 41b may manage these information in association with “virtual space ID” that identifies individual virtual spaces which are virtual communication spaces used by distributor users to distribute contents in the content distribution service according to the embodiment.

Here, in the content distribution service according to an embodiment, a distributor user can distribute a real-time content to an audience user via the virtual space associated with the distributor user. For instance, when a user who wishes to distribute a content instructs generation of a virtual space to the server 10, the server 10 generates a virtual space for this distributor user, a virtual space II) identifying the virtual space is registered in the distribution state management table 41b, and the user ID of the distributor user is registered in association with the virtual space ID. The distribution states (the elapsed time, the number of items, the number of posts, the number of audience users, and the like) may be appropriately updated in accordance with progress of the content distribution (change in the distribution state). In one embodiment, the virtual space generated in response to the instruction by the distribution user may be repeatedly used for content distributions by the distributor user. The distribution state in the distribution state management table 41a may be cleared each time a content distribution finishes (or each time a new content distribution is initiated) and a distribution state concerning a newly-initiated content distribution is managed in the table.

The user information management unit 42 according to one embodiment performs various processing concerning management of the user information including the above-described display-image setting process. More specifically, the user information management unit 42 specifies a preset image that is to be recommended as the display-image for the distributor user among prescribed preset images (predetermined images) based on various information associated with the distributor user (distributor-user related information). The user information management unit 42 may select one from among one or more images including the recommended preset image and may set the image as the display-image for the distributor user.

In one embodiment, the user information management unit 42 may, in response to change in the content distribution state, specify one preset image (a first prescribed image) from among the preset images based on the state of the content distribution, and may set the specified preset image as the display-image for the distributor user.

In one embodiment, the user information management unit 42 may present a distributor user an image selection screen on which selection of an image to be set as the display-image can be performed. The image which the distributor user selected on the image selection screen may be set as the display-image. Moreover, the user information management unit 42 may present the image selection screen to the distributor user when the distributor user instructed a switch from video distribution to audio distribution via a distributor user screen which will be later described in detail.

For instance, the user information management unit 42 may send HTML data of a screen such as the image selection screen to the terminal 30 of the distributor user. The received HTML data may be rendered on the terminal 30 using a functionality of web browser or the like and the screen may be presented as the image selection screen to the distributor user. Alternatively, the user information management unit 42 may send control data for controlling displaying of the screen to the terminal 30 of the distributor user. The terminal 30 may render the screen using a functionality of an application in accordance with the received control data and the image selection screen may be presented to the distributor user.

Furthermore, in one embodiment, the user information management unit 42 may update a level of the distributor user in accordance with video/audio distributions performed by a distributor user. For instance, the user information management unit 42 may update the level in the user information management table 41a such that the level of the distributor user is increased as the number of content distributions and/or the total time of content distributions by the distributor user increases.

The content distribution control unit 43 according to one embodiment controls content distributions performed by a distributor user. More specifically, the content distribution control unit 43 may respond to a request from a distributor user and present, to the distributor user, the distributor user screen on which the user can instruct switching between video distribution or audio distribution. Moreover, the content distribution control unit 43 according to one embodiment may respond to a request from an audience user and present, to the audience user, an audience user screen that includes a display region where the display-image can be shown when audio is distributed by the distributor user and video can be shown when the video is distributed by the distributor user. For instance, the content distribution control unit 43 may send HTML data of screen such as the distributor user screens and the audience user screen to the terminals 30 of the users. The received HTML data may be rendered on the terminals 30 using a functionality of web browser or the like and the screens may be presented to the users. Alternatively, the content distribution control unit 43 may send control data for controlling displaying of the screens to the terminals 30 of the users. The terminals 30 may render the screen using a functionality of an application in accordance with the received control data and the screens may be presented to the users.

The content distribution control unit 43 according to one embodiment may manage distribution states concerning individual content distributions performed by a distributor user. For instance, the content distribution control unit 43 may update the distribution states (the elapsed time, the number of items, the number of posts, the number of audience users, and the like) managed in the distribution state management table 41h in accordance with the progress of the individual content distribution.

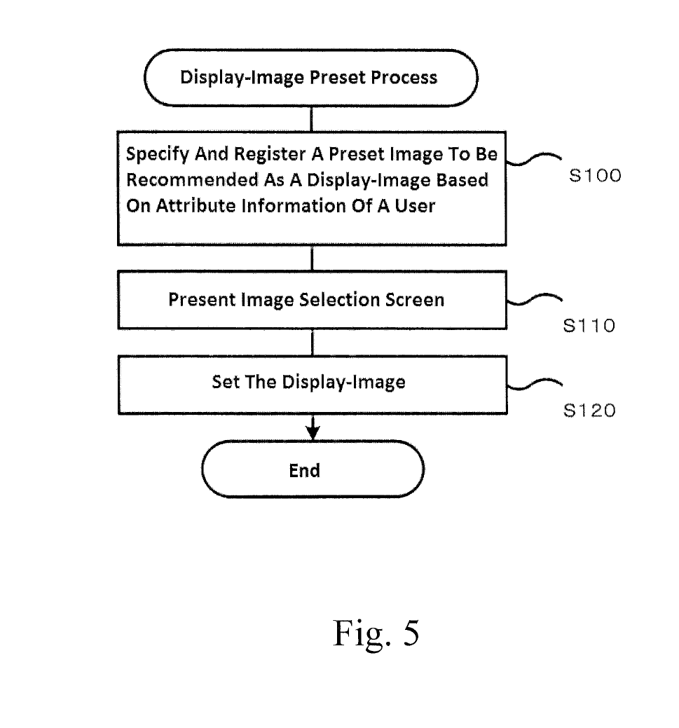

Next, operations of the server 10 according to one embodiment, in particular, the operation to set and update the display-image shown at the time of audio distribution will be now described. Firstly, an operation to preset the display-image prior to performing content distribution by a distributor user will be described, and secondly an operation to update the display-image during the content distribution will be described FIG. 5 is a flow diagram showing an example of a display-image preset process performed by the server 10 when a distributor user sets a display-image in advance. Referring to FIG. 5, in the display-image preset process, a present image may be firstly specified based on attribute information of the distributor user and may register the specified preset image as a recommended display-image (step S100). More specifically, the server 10 may specify the preset image to be recommended to a distributor user based on the attribute information (for example, gender, age, occupation, level and the like) of the distributor user managed in the user information management table 41a, and then the information about the specified preset image may be registered as the recommended preset image information in the user information management table 41a. This step may be performed at a predetermined timing such as when a user newly sings on a content distribution service and when the level of the distributor user is changed.

In one embodiment, a plurality of preset images that can be set as a display-image may be provided in advance by an operator of the content distribution service or the like. In this case, the recommended preset image is specified from among the plurality of the preset images in the step S100. The plurality of preset images may be stored in the storage 15 or the like of the server 10 in advance. Additionally or alternatively, the plurality of preset images may be stored in the storage 35 or the like of the terminal 30 when an application of the content distribution service is installed and/or updated or the like.

Various rules may be adopted to specify the recommended preset image based on the attribute information of the user. For instance, correspondence relationships between recommended preset images and one type (for instance, occupation) or two types combined (for instance, a combination of gender and age) of the attribute information of the user may be specified in advance. A preset image may be then specified in accordance with the correspondence relationships so that a preset image corresponding to the attribute information of the user will be selected. Alternatively, as the level of the user increases, the number of the recommended preset images may be increased and/or a preset image with a higher rarity may be recommended. In one embodiment, the number of the recommended preset images is not particularly limited. One or more preset images may be recommended.

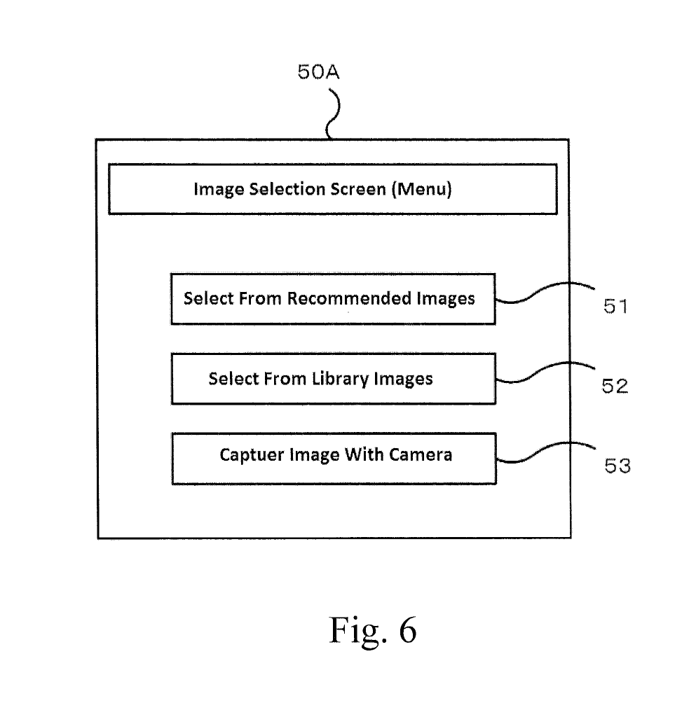

After the recommended preset image has specified and registered, the image selection screen is presented to the distributor user in response to a request from the distributor user (step S110). The distributor user can select an image to set as the display-image via the image selection screen. FIG. 6 illustrates an example of a menu screen 50A of the image selection screen shown on the terminal 30 of the distributor user according to the embodiment. The menu screen 50A may include a recommended image selection button 51 denoted as “select from recommendation,” a library image selection button 52 denoted as “select from library,” and an image capture button 53 denoted as “capture image with camera.” In one embodiment, a user can set the display-image by selecting one from among the recommended preset images (the recommended image selection button 51), by selecting one from among the images owned by the user (the library image selection button 52), and by newly capturing an image (the image capture button 53).

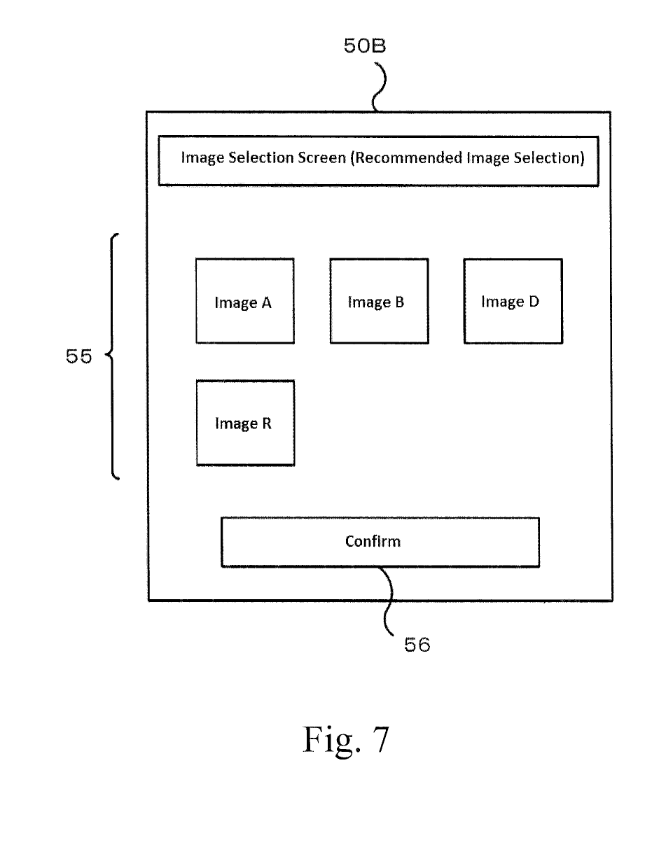

When a user selected the recommended image selection button 51, a recommended image selection screen 50B of the image selection screen illustrated in FIG. 7 is shown. Referring to FIG. 7, the recommended image selection screen SOB may include a recommended image display region 55 where a list of the recommended preset images are shown, and a confirm button 56 denoted as “confirm.” The preset images within the recommended image display region 55 (the four preset images A, B, D, and R in the example of FIG. 7) are the preset images specified based on the user attribute information in the above-described step S100, and shown based on the recommended preset image information in the user information management table 41a.

When the user selected one from among the images within the recommended image display region 55 and pressed the confirm button 56, the selected image is set as the display-image (step S120), and the display-image preset process is completed. More specifically, the information about the selected image is registered as the set display-image information in the user information management table 41a.

Moreover, when a user selected the library image selection button 52 on the menu screen 50A of the image selection screen, the user can select a desired image from among the images owned by the user (the images may be stored in the storage 35 of the terminal 30 or the storage 15 or the like of the server 10) to set the image as the display-image. When a user selected the image capture button 53, the user can capture an image using a camera in the terminal 30 and the captured image can be set as the display-image. Such processes will be obvious to ones skilled in the art and the description thereof is hereunder omitted.

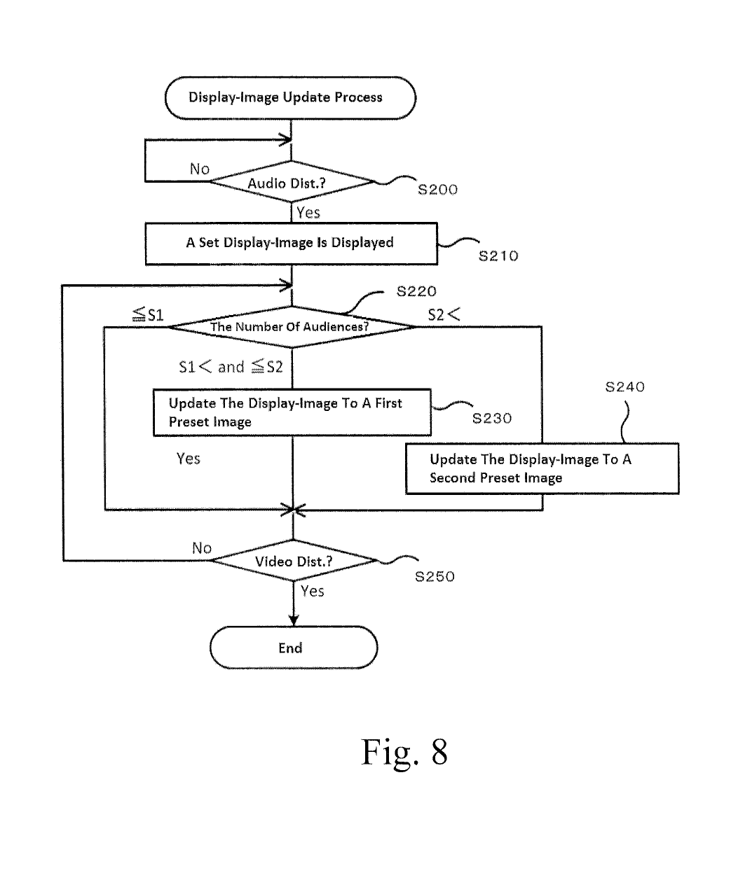

The operation to preset the display-image by a distribution user has been described. An operation to update the display-image during distribution of a content will be now described. FIG. 8 is a flow diagram showing an example of the display-image update process. The display-image update process may be repeatedly performed by the server 10 during a distribution user distributes a content.

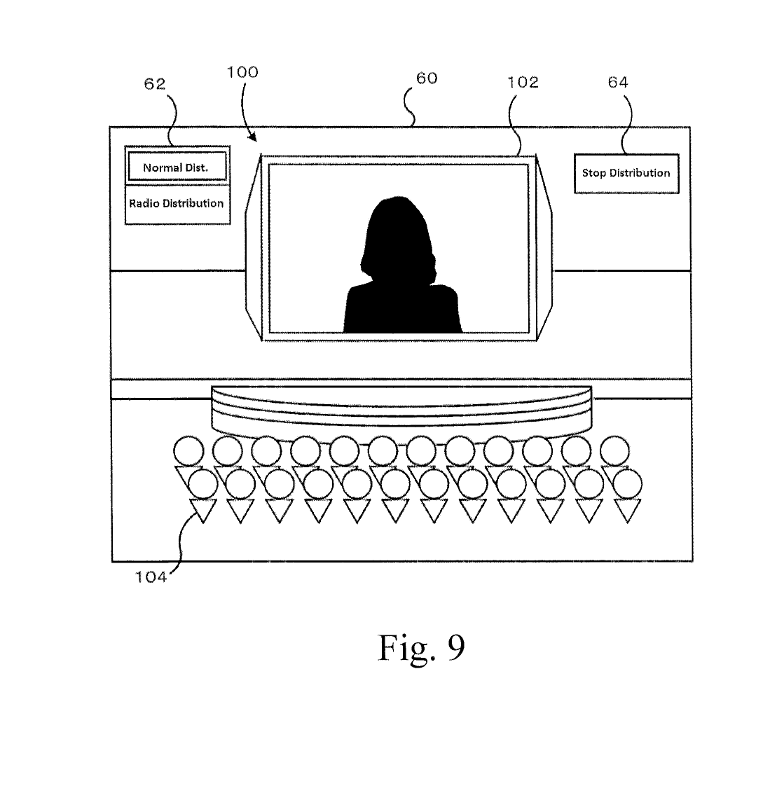

Referring to FIG. 8, in the display-image update process, whether a distributor user initiates audio distribution is watched (step S200). Here, firstly described are the distributor user screen and the audience user screen presented to the distributor user and the audience user respectively in the content distribution service according to an embodiment. FIG. 9 illustrates an example of a distributor user screen 60 displayed on the terminal 30 of a distributor user in response to a request from the distributor user. Referring to FIG. 9, on the distributor user screen 60, the virtual space 100 for the distributor user to distribute contents is shown on the whole screen. A distribution switch button 62 and a distribution control button 64 are superposed on the screen at the upper left corner and the upper right corner respectively. In the virtual space 100, a content display object (display region) 102 for displaying a content distributed by the distributor user is placed in the upper central area of the screen, and avatars 104 of a plurality of audience users participating in the virtual space 100 are placed in the lower area of the screen.

The distribution switch button 62 on the distributor user screen 60 is a button through which the distribution user instructs switching between video distribution or audio distribution. FIG. 9 illustrates a state where the distribution user performs a video distribution (normal distribution), and when the distribution user selects the distribution switch button 62 in this state, the distribution is switched from the video to audio (radio distribution).

The distribution control button 64 on the distributor user screen 60 is a button through which the distribution user instructs switching between ON/OFF of content distribution. FIG. 9 illustrates the state where the distribution user is performing the content distribution, and the distribution control button 64 shows “stop distribution.” When the user selected the distribution control button 64 in this state, the distribution of content is turned OFF and the distribution control button 64 then shows “start distribution.”

The content display object 102 in the virtual space 100 displays a content which a distributor user delivers. For instance, the server 10 that receives real-time video data provided through a camera and microphone of the terminal 30 of the distributor user displays the video in the content display object 102 based on the received video data. When a distributor user distributes audio, a display-image is shown in the content display object 102, which will be later described.

As described above, the distributor user screen 60 is configured to allow a distributor user to check the states of the distributing contents and the states of audience users via the virtual space 100, and allow the distributor user to control the distribution via the distribution switch button 62 and the distribution control button 64.

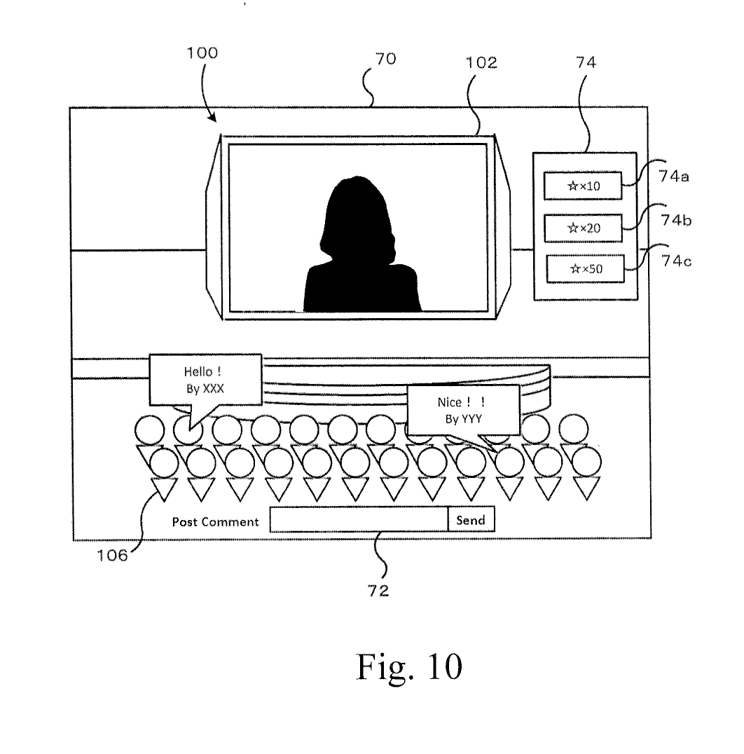

FIG. 10 illustrates an example of the audience user screen 70 displayed on the terminal 30 of an audience user in response to a request from the audience user who views a content. The audience user can select a desired distributor user from among a plurality of distributor users (or corresponding virtual spaces) in the content distribution service and can enter the corresponding virtual space by selecting the desired distributor user. Subsequently the audience user screen 70 is displayed on the terminal 30. Referring to FIG. 10, like the distributor user screen 60, the virtual space 100 which the user entered is shown on the whole of the audience user screen 70. A comment posting region 72 is superposed on the lower central area of the audience user screen 60, and an item input region 74 is superposed on the upper right corner of the screen.

The comment posting region 72 may be configured to allow input of a desired character string by the audience user. When the audience user makes an instruction for sending the inputted character string, the inputted character string may be sent to the server 10 and displayed in a balloon from the avatar 106 of the user in the virtual space 100 (FIG. 10 shows, e.g., “Hello! by XXXX” and “Nice! by YYYY” (“XXXX” and “YYYY” are names or nicknames of the users)). Thus, the audience user screen 70 in an embodiment may be configured such that the audience users entered in the same virtual space 100 can perform text chat with each other. The comments (character strings and the like) posted via the comment posting region 72 may be also shown on the distributor user screen 60 so that audience users can enjoy communication with the distribution user by using the text chat feature.

The item drop region 74 is a region for an audience user to input “the number of items to drop in,” and may include a first button 74a for dropping ten items, a second button 74b for dropping twenty items, and a third button 74c for dropping fifty items. When a user selected any one of the buttons included in the item drop region 74, a visual effect (animation) is played such that the number of items (for instance, star-shaped items and the like) corresponding to the selected button are thrown from the avatar of the audience user toward the content display object 102.

In one embodiment, the audience user can purchase the items using virtual values such as virtual currency and coins or the items are made available to the users for free at various occasions. The dropping of the items may be performed within the number of items which the audience user possesses. For instance, the audience user may express positive feelings to a distributor user by dropping item(s) in.

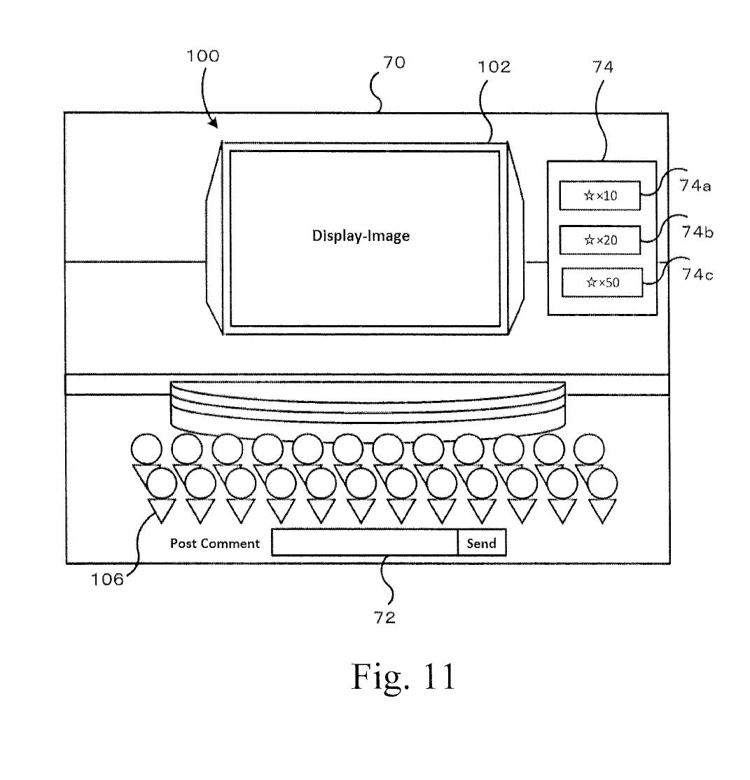

Referring back to the flow diagram of FIG. 8, when distribution of audio is performed by the distribution user, a set display-image is displayed (step S210). More specifically, when the distribution user instructed switching from the video distribution to audio distribution via the distribution switch button 62 on the distributor user screen 60, for example, the server 10 may display, in the content display object 102 of the virtual space 100, an image that is registered in the set display-image information in the user information management table 41a (see FIG. 11).

The display-image update process (steps S220-S250) is then repeated in accordance with the number of audience users entered in the virtual space 100 until the distribution is switched from the audio distribution to video distribution. More specifically, display of the current display-image may be maintained when the number of the audience users is equal to or less than a first threshold value S1 (for instance, 1,000), the display-image may be updated to a first preset image when the number of the audience users is larger than the first threshold value S1 and equal to or less than a second threshold value S2 (for instance, 5,000) larger than the first threshold value (step S230), the display-image may be updated to a second preset image when the number of the audience users is larger than the second threshold value S2 (step S240). Here, the number of audience users is managed in the distribution state management table 41b. More specifically, a process to update the display-image to a preset image may include overwriting the set display-image information in the user information management table 41a with the information about the preset image, and displaying the preset image in the content display object 102 of the virtual space 100. As described above, in the content distribution service according to the embodiment, the recommended preset image is specified based on the number of audience users, and the specified preset image is automatically shown as the display-image.

Here, in one embodiment, the preset image specified based on the number of audience users may be different or identical from/to a preset image specified in the display-image preset process based on the user attribute information.

When the distribution is then switched from the audio distribution to a video distribution (step S250), the display-image update process is terminated. Note that the display-image update process is repeatedly performed during content distribution performed by a distribution user as mentioned above. Therefore when the distribution is again switched from the video distribution to an audio distribution, the above-described steps S210-S250 is performed again. When the content distribution is terminated (for instance, when a distributor user turns OFF the content distribution via the distribution control button 64 on the distributor user screen 60), the display-image update process is also terminated.

The recommended preset image is specified based on the number of audience users in the above-described embodiment. Alternatively, the recommended preset image may be specified based on information about the distribution states other than the number of audience users. For instance, the recommended preset image may be specified based on the number of items (managed in the distribution state management table 41b) which an audience user drops via the item drop region 74 on the audience user screen 70 (for instance, the recommended preset image is updated to the first preset image when the number of dropped items exceeds 500, and updated to the second preset image when the number of dropped items exceeds 2000, and the like). Alternatively, the recommended preset image may be specified based on the number of comments which the audience user posted via the comment posting region 72 on the audience user screen 70 (for instance, the recommended preset image is updated to the first preset image when the number of comments exceeds 100, and updated to the second preset image when the number of comments exceeds 1000, and the like). In this manner, the embodiments of the disclosure encompass various ways to specify the recommended preset image based on various types of input information received from the audience users. Alternatively, the recommended preset image may be specified based on an elapsed time since the start of the content distribution (for instance, the recommended preset image is updated to the first preset image when the elapsed time exceeds thirty minutes, and updated to the second preset image when the elapsed time exceeds sixty minutes, and the like).

The recommended preset image is automatically set as the display-image during the content distribution in the above-described embodiment. However, the recommended preset image may be set as the display-image when the distributor user selected and instructed, without automatically setting. For instance, a screen corresponding to the recommended image selection screen 50B of the image selection screen may be shown when the number of audience users exceeds the threshold value S1 or S2. The distributor user may then select an image to be set as the display-image from among images including the recommended preset image.

The server 10 according to the above-described embodiment specifies at least one preset image to be recommended as a display-image for a distributor user from among a plurality of preset images (predetermined images) based on attribute information of the distributor user and the number of audience users during a content distribution (distributor-user related information). The server 10 then sets, from among one or more images including the recommended preset image, one image as a display-image for the distributor user. The server 10 further presents, in response to a request from a distributor user, the distributor user screen 60 on which the distributor user can instruct switching between video distribution or audio distribution. The server 10 further displays, in response to a request from an audience user, the audience user screen 70 that includes the content display object 102 (display region) of the virtual space 100 in which video is shown when the video is distributed by the distributor user and the display-image is shown when audio is distributed by the distributor user. As described above, the server 10 according to the embodiments can recommend a preset image specified based on the information related to the distributor user as the display-image. In this way, it is possible to facilitate setting, by a user, an image to be displayed at the time of audio distribution.

The server 10 according to one embodiment may specify a preset image (the first preset image) based on the number of audience users (the distribution state) in accordance with the progress of content distribution (a change in the distribution state), and may set the specified preset image as the display-image for the distributor user. In this manner, the preset image is automatically set as the display-image in accordance with the progress of content distribution, and thereby it is possible to facilitate setting of the display-image by the user at the time of audio distribution.

The processes and procedures described and illustrated herein may also be implemented by software, hardware, or any combination thereof other than those explicitly stated for the embodiments. More specifically, the processes and procedures described and illustrated herein may be implemented by the installation of the logic corresponding to the processes into a medium such as an integrated circuit, a volatile memory, a non-volatile memory, a magnetic disk, or an optical storage. The processes and procedures described and illustrated herein may also be installed in the form of a computer program, and executed by various computers.

Even if the processes and the procedures described herein are executed by a single apparatus, software piece, component, or module, such processes and procedures may also be executed by a plurality of apparatuses, software pieces, components, and/or modules. Even if the data, tables, or databases described herein are stored in a single memory, such data, tables, or databases may also be dispersed and stored in a plurality of memories included in a single apparatus or in a plurality of memories dispersed and arranged in a plurality of apparatuses. The elements of the software and the hardware described herein can be integrated into fewer constituent elements or can be decomposed into more constituent elements.

With respect to the use of substantially any plural and/or singular terms herein, those having skill in the art can translate from the plural to the singular and/or from the singular to the plural as is appropriate to the context.

What is claimed is:

1. A system for distributing video or audio by a distributor user to an audience user, comprising:
one or more computer processors,
wherein the one or more computer processors execute a readable instruction to perform:
specifying, from among a plurality of preset images, at least one prescribed image that is to be recommended as a display-image for a distributor user based on distributor-user related information associated with the distributor user;
presenting, to the distributor user, an image selection screen on which the distributor user can select one image to be set as the display-image from among a plurality of images including the at least one prescribed image;
setting, as the display-image, the image selected via the image selection screen by the distributor user;
in response to a request from a distributor user, presenting, to the distributor user, a distributor user screen on which the distributor user can instruct switching between video distribution or audio distribution; and
in response to a request from an audience user, presenting, to the audience user, an audience user screen that includes a display region where video is shown when the video is distributed by the distributor user and the display-image is shown when audio is distributed by the distributor user.

2. The system of claim 1, wherein the distributor-user related information includes a level of the distributor user, and
the one or more computer processors further performs updating the level of the distributor user in accordance with video or audio distributions by the distributor user.

3. The system of claim 1, wherein the distributor-user related information includes the number of audience users who view/listen video/audio distributed by the distributor user.

4. The system of claim 1, wherein the audience user screen is configured to receive input information from the audience user, and
the distributor-user related information includes the input information received via the audience user screen.

5. The system of claim 1, wherein the distributor-user related information includes an elapsed time since start of video or audio distribution by the distributor user.

6. The system of claim 1, wherein presenting the image selection screen includes presenting the image selection screen to the distributor user when the distributor user instructed switching from video distribution to audio distribution via the distributor user screen.

7. A method using one or more computers for distributing video or audio by a distributor user to an audience user, the method comprising:
specifying, from among a plurality of preset images, at least one prescribed image that is to be recommended as a display-image for a distributor user based on distributor-user related information associated with the distributor user;
presenting, to the distributor user, an image selection screen on which the distributor user can select one image to be set as the display-image from among a plurality of images including the at least one prescribed image;
setting, as the display-image, the image selected via the image selection screen by the distributor user;
in response to a request from a distributor user, presenting, to the distributor user, a distributor user screen on which the distributor user can instruct switching between video distribution or audio distribution; and
in response to a request from an audience user, presenting, to the audience user, an audience user screen that includes a display region where video is shown when the video is distributed by the distributor user and the display-image is shown when audio is distributed by the distributor user.

8. A storage medium storing a program for distributing video or audio by a distributor user to an audience user, comprising:
the program being configured to cause, upon execution on a computer, the computer to perform:
specifying, from among a plurality of preset images, at least one prescribed image that is to be recommended as a display-image for a distributor user based on distributor-user related information associated with the distributor user;
presenting, to the distributor user, an image selection screen on which the distributor user can select one image to be set as the display-image from among a plurality of images including the at least one prescribed image;
setting, as the display-image, the image selected via the image selection screen by the distributor user;
in response to a request from a distributor user, presenting, to the distributor user, a distributor user screen on which the distributor user can instruct switching between video distribution or audio distribution; and
in response to a request from an audience user, presenting, to the audience user, an audience user screen that includes a display region where video is shown when the video is distributed by the distributor user and the display-image is shown when audio is distributed by the distributor user.
